(19) United States
(12) Patent Application Publication
(10) Pub. No.: US 2025/0265887 A1
(43) Pub. Date: Aug. 21, 2025

(54) AUTOMATED TELLER MACHINE

(71) Applicant: HYOSUNG TNS INC., Seoul (KR)

(72) Inventors: Sung Chang HUR, Seoul (KR); Myungwoo LEE, Seoul (KR); Seungin LEE, Seoul (KR); Hyeram CHO, Seoul (KR); Seungsik JEONG, Seoul (KR); Youngho HAN, Seoul (KR)

(21) Appl. No.: 19/056,952

(22) Filed: Feb. 19, 2025

(30) Foreign Application Priority Data
Feb. 19, 2024 (KR) 10-2024-0023715
Nov. 29, 2024 (KR) 10-2024-0175492

(51) Int. Cl. G07D 11/18; B65H 3/06; B65H 7/02; G07D 11/14; G07D 11/235

(52) U.S. Cl. CPC G07D 11/18; B65H 3/0669; B65H 7/02; G07D 11/14; G07D 11/235; B65H 2403/41; G07D 2207/00; G07D 2211/00

(57) ABSTRACT

An automated teller machine includes: a deposit and withdrawal unit configured to allow deposit and withdrawal of a medium, which allows a bundle of media including multiple stacked media to be deposited; a discrimination unit that discriminates the medium; a storage unit in which the medium is stored; a conveyance path that transfers the medium between the deposit and withdrawal unit, the discrimination unit, and the storage unit. The deposit and withdrawal unit includes: a push plate unit on which the bundle of media is placed; a first pick-up roller for transferring the bundle of media in a deposit direction toward the discrimination unit when the bundle of media is placed on the push plate unit; and a second pick-up roller, disposed to be spaced apart from the first pick-up roller in the deposit direction, for transferring the medium from the bundle of media in the deposit direction.

### TECHNICAL FIELD

The present disclosure relates to an automated teller machine.

### BACKGROUND

In general, in relation to financial services, an automated teller machine (ATM) refers to an automated teller machine, such as a cash dispenser unit (CDU), a bill recycling machine (BRM) or the like, which is developed to provide most financial services unmanned, except for consultation services, quickly and conveniently without time constraints.

The automated teller machine has various additional functions, such as card processing, passbook processing, and check deposit machines, depending on the function of the financial service, in addition to the automatic cash deposit/withdrawal function.

The automated teller machine may allow media such as banknotes to be deposited in a bundle of multiple stacked media, and when the bundle of media is deposited, the automated teller machine needs to separate the bundled media into individual sheets and transfer them.

Meanwhile, the bundled media can be deposited vertically or horizontally in an automated teller machine. However, conventional automated teller machines in which a bundle of media is deposited horizontally have a relatively complex configuration for separating the deposited bundled media and transferring individual sheets. In addition, when the bundled media are separated through feed rollers and gate rollers in a deposit and withdrawal unit, the phenomenon in which the individual sheets are twisted may occur.

### SUMMARY

In view of the above, the present disclosure provides an automated teller machine having a relatively simple configuration for separating bundled media in which multiple media such as banknotes are stacked and transferring individual sheets.

Further, the present disclosure provides an automated teller machine capable of effectively preventing twisting of media in a deposit and withdrawal unit.

In accordance with a first embodiment of the present disclosure, there is provided an automated teller machine including: a deposit and withdrawal unit configured to allow deposit and withdrawal of a medium, which allows a bundle of media including multiple stacked media to be deposited; a discrimination unit that discriminates the medium; a storage unit in which the medium is stored; a conveyance path that transfers the medium between the deposit and withdrawal unit, the discrimination unit, and the storage unit, wherein the deposit and withdrawal unit includes: a push plate unit on which the bundle of media is placed; a first pick-up roller for transferring the bundle of media in a deposit direction toward the discrimination unit when the bundle of media is placed on the push plate unit; and a second pick-up roller, disposed to be spaced apart from the first pick-up roller in the deposit direction, for transferring the medium from the bundle of media in the deposit direction.

Further, the automated teller machine may further include a controller configured to control the deposit and withdrawal unit, wherein the deposit and withdrawal unit may further include: a first lifting and lowering drive unit configured to raise and lower the first pickup roller; and a second lifting and lowering drive unit configured to raise and lower the second pickup roller, and the controller may control the first lifting and lowering drive unit and the second lifting and lowering drive unit.

Further, the deposit and withdrawal unit may further include: a first medium detection sensor for detecting whether the bundle of media has reached a region directly above the push plate unit; and a second medium detection sensor, disposed to be spaced apart from the first medium detection sensor in the deposit direction, for detecting the bundle of media, and the controller may control the first lifting and lowering drive unit and the second lifting and lowering drive unit based on detection of one or both of the first medium detection sensor and the second medium detection sensor.

Further, the first pickup roller and the second pickup roller may be disposed above the push plate unit, and the controller may control the first lifting and lowering drive unit and the second lifting and lowering drive unit to lower the first pickup roller to come into contact with the bundle of media when the first medium detection sensor detects the bundle of media, and to lower the second pickup roller to come into contact with the bundle of media when the second medium detection sensor detects the bundle of media.

Further, the first lifting and lowering drive unit may include: a first lifting and lowering support arm that rotatably supports the first pickup roller at one side and is rotatable about a first arm rotation center; a lifting and lowering link connected to the first lifting and lowering support arm; and a link drive cylinder connected to the lifting and lowering link.

Further, the second lifting and lowering drive unit may include: a second lifting and lowering support arm that rotatably supports the second pickup roller at one side and is rotatable about a second arm rotation center; a lifting and lowering cam for raising and lowering the second lifting and lowering support arm; a plurality of arm lifting and lowering gears meshed with each other, one of which is connected to the lifting and lowering cam; and a lifting and lowering drive motor connected to another one of the plurality of arm lifting and lowering gears.

Further, the second lifting and lowering drive unit may further include a stopper that limits a rotation range of the lifting and lowering cam, and the lifting and lowering cam has a stopper engagement portion that moves along the stopper.

Further, the second lifting and lowering drive unit may further include at least one torque limiter configured to allow the second lifting and lowering drive unit to operate to raise the push plate unit in a state where lowering of the second pickup roller has been completed, or to allow the second lifting and lowering drive unit to operate to lower the second pickup roller in a state where lifting of the push plate unit has been completed.

Further, the second lifting and lowering drive unit may be configured to raise and lower the push plate unit while raising and lowering the second pickup roller.

Further, when the second medium detection sensor detects the bundle of media, the controller may control the second lifting and lowering drive unit to lower the second pickup roller to contact an upper surface of the bundle of media, and to raise the push plate unit to push the bundle of media upward.

Further, the second lifting and lowering drive unit may further include: a rack gear disposed on the push plate unit; a pinion gear meshed with the rack gear to move along the rack gear; and a plate lifting and lowering gear connected to the pinion gear and the torque limiter.

Further, the deposit and withdrawal unit may further include a transfer assistance roller for working together with the first pickup roller to transfer the bundle of media in the deposit direction.

Further, the deposit and withdrawal unit may further include a friction member disposed on the push plate unit below the second pickup roller.

In accordance with a second embodiment of the present disclosure, there is provided an automated teller machine including: a deposit and withdrawal unit configured to allow deposit and withdrawal of media as a bundle of media in which multiple media are stacked; a discrimination unit that discriminates the media; a sheet transfer unit that transfers media separated into individual sheets from the bundle of media to the discrimination unit; and a controller configured to control the deposit and withdrawal unit, the discrimination unit, and the sheet transfer unit, wherein the deposit and withdrawal unit includes: a push plate unit on which the bundle of media is placed; a first pick-up roller for transferring the bundle of media in a deposit direction of the media when the bundle of media is placed on the push plate unit; and a second pick-up roller, disposed to be spaced apart from the first pick-up roller in the deposit direction, for providing the media of the bundle of media to the sheet transfer unit, and wherein the controller controls the first pick-up roller and the second pick-up roller to operate together when the media are conveyed to the sheet transfer unit.

Further, the deposit and withdrawal unit may further include: a first medium detection sensor disposed between the first pickup roller and the second pickup roller to detect whether at least a portion of the bundle of media has reached a region directly above the push plate unit; a second medium detection sensor disposed between the second pickup roller and the sheet transfer unit to detect whether at least a portion of the bundle of media has reached a standby position before being fed into the sheet transfer unit; a first lifting and lowering drive unit configured to raise and lower the first pickup roller; and a second lifting and lowering drive unit configured to raise and lower the second pickup roller, and the controller may control the first lifting and lowering drive unit and the second lifting and lowering drive unit to lower the first pickup roller to come into contact with the bundle of media when the first medium detection sensor detects the bundle of media, and to lower the second pickup roller to come into contact with the bundle of media when the second medium detection sensor detects the bundle of media.

Further, the first lifting and lowering drive unit may include: a first lifting and lowering support arm that rotatably supports the first pickup roller at one side and is rotatable about a first arm rotation center; a lifting and lowering link connected to the first lifting and lowering support arm; a link drive cylinder connected to the lifting and lowering link; and a first elastic spring that provides elastic force to the first lifting and lowering support arm to move the first pickup roller to its initial position when the link drive cylinder is not operated.

Further, the controller may control the first lifting and lowering drive unit to lower the first pickup roller to come into contact with the bundle of media when the first medium detection sensor detects the bundle of media, to raise the first pickup roller to be separated from the bundle of media when the second medium detection sensor detects the bundle of media, and to lower and raise the first pickup roller for a preset period of time to repeatedly contact and separate from the bundle of media.

Further, the second lifting and lowering drive unit may include: a second lifting and lowering support arm that rotatably supports the second pickup roller at one side and is rotatable about a second arm rotation center; a lifting and lowering cam for lifting and lowering the second lifting and lowering support arm; a plurality of arm lifting and lowering gears meshed with each other, one of which is connected to the lifting and lowering cam; a lifting and lowering drive motor connected to another one of the plurality of arm lifting and lowering gears; and a second elastic spring that provides elastic force to the second lifting and lowering support arm in a direction to press the second pickup roller against the bundle of media.

Further, the second lifting and lowering drive unit may raise and lower the second pickup roller and the push plate unit together so that the second pickup roller and the push plate unit move away from or closer to each other.

Further, when the second medium detection sensor detects the bundle of media, the controller may control the second lifting and lowering drive unit to lower the second pickup roller to contact an upper surface of the bundle of media, and to raise the push plate unit to push the bundle of media upward.

According to embodiments of the present disclosure, bundled media in which multiple media such as banknotes are stacked can relatively easily be separated and transferred as individual sheets.

According to embodiments of the present disclosure, when the medium is transferred to a position where the individual sheet transfer unit (feed roller and gate roller) is located, the first pickup roller and the second pickup roller contact the front and rear portions of the medium at two points to transport it, which ensures the prevention of intermittent twisting of the media in advance.

### BRIEF DESCRIPTION OF THE DRAWINGS

FIG. 1 is a schematic diagram showing an automated teller machine according to a first embodiment of the present disclosure.

FIG. 2 is a perspective view showing a deposit and withdrawal unit of the automated teller machine in FIG. 1 with one side cover removed.

FIG. 3 is a cross-sectional view taken along line III-III of FIG. 2.

FIG. 4 is a cross-sectional view taken along line IV-IV of FIG. 2.

FIG. 5 is a cross-sectional view taken along line V-V of FIG. 2.

FIG. 6 is a cross-sectional view taken along line VI-VI of FIG. 2.

FIG. 7 is a cross-sectional view taken along line VII-VII of FIG. 2.

FIG. 8 is a cross-sectional view taken along line VIII-VIII of FIG. 2.

FIG. 9 is a drawing showing the operation of the deposit and withdrawal unit of FIG. 2, showing that a bundle of media in which multiple media such as banknotes are stacked is deposited in the deposit and withdrawal unit and placed on a push plate unit.

FIG. 10 is a drawing showing the operation of the deposit and withdrawal unit of FIG. 2, showing that a first pickup roller is lowered to contact the bundle of media.

FIG. 11 is a drawing showing the operation of the deposit and withdrawal unit of FIG. 2, showing that the bundle of media is transferred in the deposit direction from the push plate unit by the first pickup roller and a transfer assistance roller.

FIG. 12 is a drawing showing the operation of the deposit and withdrawal unit of FIG. 2, showing that a second pickup roller is lowered to contact the bundle of media and the push plate unit is raised.

FIG. 13 is a drawing showing the operation of the deposit and withdrawal unit of FIG. 2, showing that an upper medium in the bundle of media is transferred in the deposit direction by the second pickup roller and transferred to a sheet transfer unit.

FIG. 14 is a drawing showing the operation of the deposit and withdrawal unit of FIG. 2, showing that the medium transferred to the sheet transfer unit is transferred in the deposit direction by the sheet transfer unit.

FIG. 15 is a perspective view showing a deposit and withdrawal unit of an automated teller machine according to a second embodiment of the present disclosure.

FIG. 16 is a cross-sectional view taken along line XVI-XVI of FIG. 15.

FIG. 17 is a cross-sectional view taken along line XVII-XVII of FIG. 15.

FIG. 18 is a cross-sectional view taken along line XVIII-XVIII of FIG. 15.

FIG. 19 is a cross-sectional view taken along line XIX-XIX of FIG. 15.

FIG. 20 is a drawing showing a state in which a bundle of media in which multiple media are stacked is deposited in the deposit and withdrawal unit and placed on a transfer assistance roller.

FIG. 21 is a drawing showing a state in which the first pickup roller is lowered to contact the bundle of media.

FIG. 22 is a drawing showing a state in which the second pickup roller is lowered to contact the bundle of media and a push plate unit is raised.

FIG. 23 is a drawing showing a state in which the first pickup roller and the second pickup roller contact the bundle of media at two points.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, or ‘coupled’ to another element, it should be understood that the element may be directly connected to, supported by, or coupled another element, but that other elements may exist in the middle.

The terms used in the present disclosure are only used for describing specific embodiments, and are not intended to limit the present disclosure. Singular expressions include plural expressions unless the context clearly indicates otherwise.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

In the present specification, expressions such as upper side, lower side and the like are described based on the drawings, but it is to be noted that when the orientation of the corresponding subject is changed, it may be expressed differently.

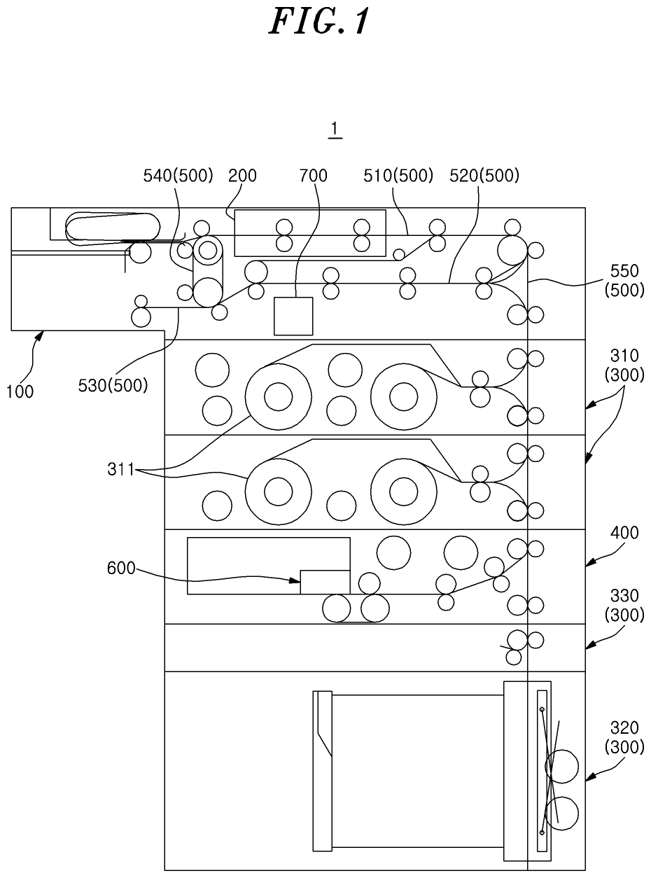

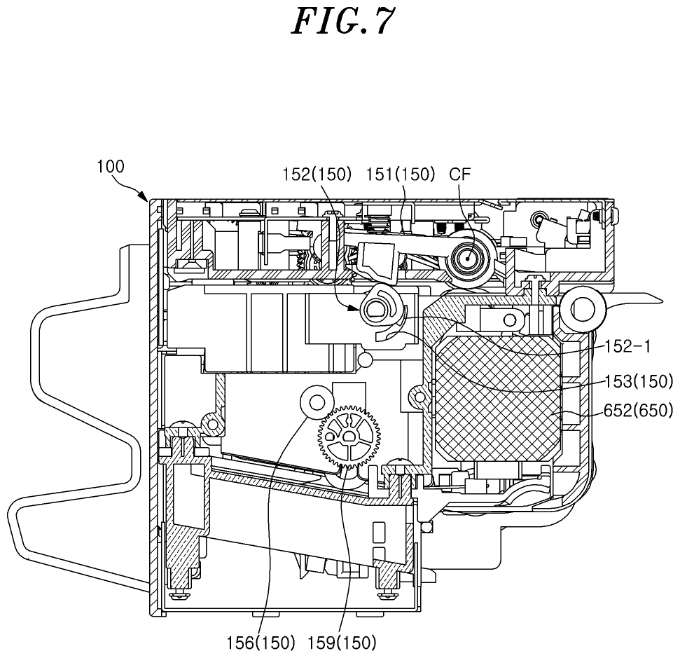

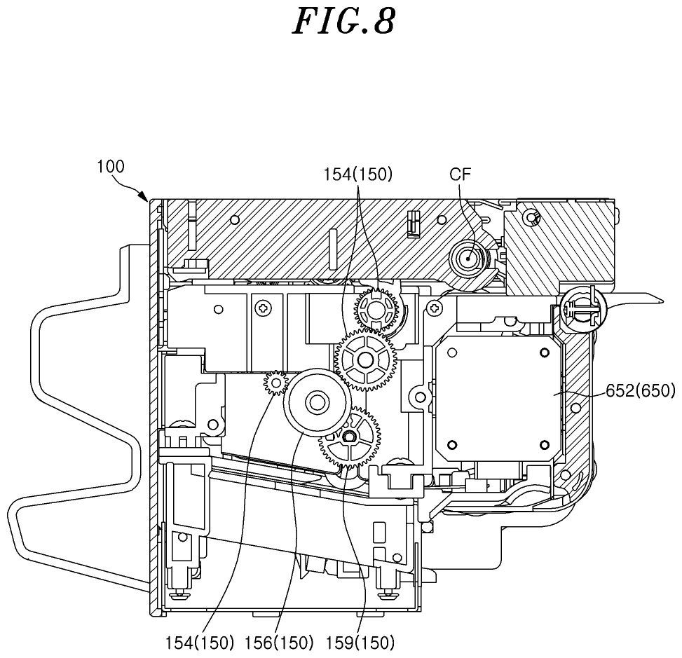

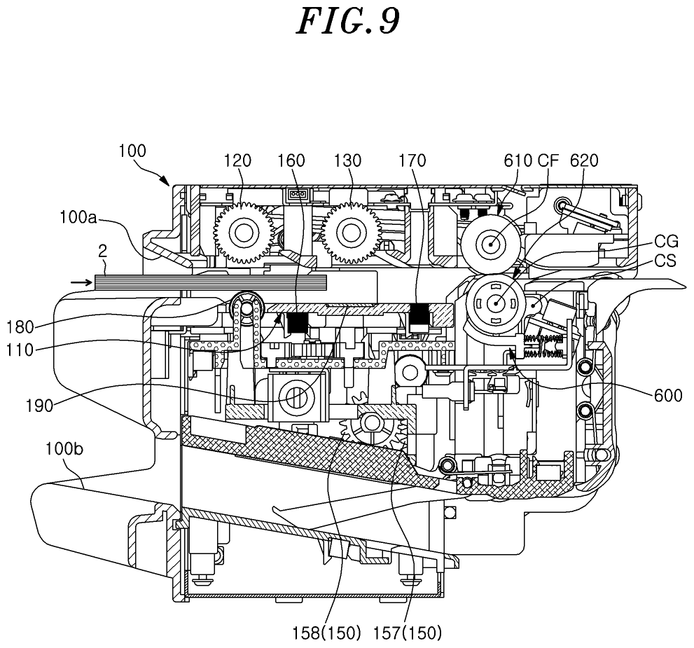

Hereinafter, with reference to FIGS. 1 to 14, a specific configuration of an automated teller machine 1 according to a first embodiment of the present disclosure will be described. A medium 2-1, such as a banknote, can be deposited into the automated teller machine 1. Further, a bundle of media 2 (see FIG. 9) in which multiple media 2-1 are stacked can be deposited into the automated teller machine 1. While separating the deposited bundled media 2 into individual sheets and transferring the individual sheets, the automated teller machine 1 can discriminate the media 2-1, and can classify and store the media 2-1 or return the media 2-1 to a user (not shown) based on the discrimination results. In addition, the automated teller machine 1 can transfer the stored media 2-1 for withdrawal by a user. The automated teller machine 1 may include a deposit and withdrawal unit 100, a discrimination unit 200, a storage unit 300, a medium replenishment unit 400, a conveyance path 500, a sheet transfer unit 600, and a controller 700.

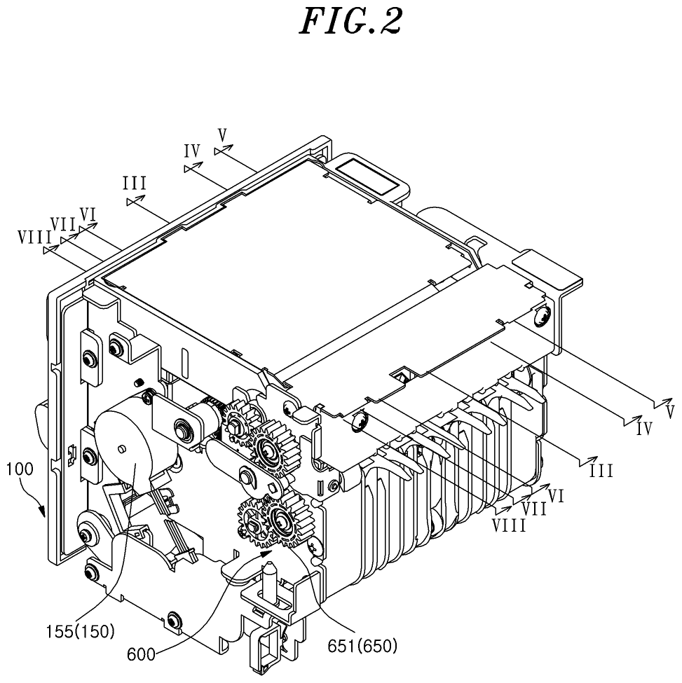

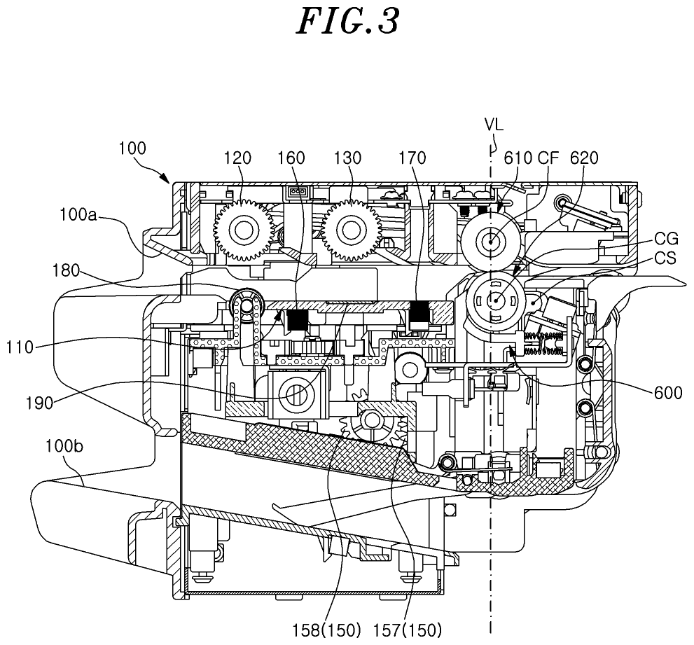

Referring to FIGS. 2 and 3, a medium 2-1 such as banknotes can be deposited and withdrawn through the deposit and withdrawal unit 100. The deposit and withdrawal unit 100 may be configured so that, when media 2-1 are deposited, they can be deposited as a bundle of media 2 in which multiple media 2-1 are stacked. The bundle of media 2 may be deposited horizontally longitudinally in the deposit and withdrawal unit 100. In other words, the bundle of media 2 may be deposited horizontally along its longer longitudinal dimension in the deposit and withdrawal unit 100. The deposit and withdrawal unit 100 may have a first entry and exit port 100a and a second entry and exit port 100b. The first entry and exit port 100a may be a deposit-only port, and the bundle of media 2 may be deposited in the first entry and exit port 100a. The second entry and exit port 100b may be a withdrawal-only port, and a medium 2-1 may be withdrawn therethrough. The deposit and withdrawal unit 100 may include a push plate unit 110, a first pickup roller 120, a second pickup roller 130, a first lifting and lowering drive unit 140, a second lifting and lowering drive unit 150, a first medium detection sensor 160, a second medium detection sensor 170, a transfer assistance roller 180, and a friction member 190.

A bundle of media 2 may be placed on the push plate unit 110. The push plate unit 110 may extend in a deposit direction toward the discrimination unit 200. The bundle of media 2 may be placed on the push plate unit 110 by a user (not shown) through the first entry and exit port 100a. For example, the bundle of media 2 may be placed on an upper surface of the push plate unit 110. The push plate unit 110 may be raised and lowered by the second lifting and lowering drive unit 150.

The first pickup roller 120 can transfer the bundle of media 2 in the deposit direction when the bundle of media 2 is placed on the push plate unit 110. The first pickup roller 120 works together with the transfer assistance roller 180 to move the bundle of media 2 in the deposit direction. The first pickup roller 120 is disposed above the push plate unit 110 and can be raised and lowered by the first lifting and lowering drive unit 140. In addition, the first pickup roller 120 can be rotated by a roller rotation drive unit 650 included in the sheet transfer unit 600 to be described later. The first pickup roller 120 may be arranged closer to the first entry and exit port 100a than the second pickup roller 130. The second pickup roller 130 can transfer a medium 2-1 from the bundle of media 2 in the deposit direction. The second pickup roller 130 can transfer the medium 2-1 from the bundle of media 2 transferred in the deposit direction from the push plate unit 110 by the first pickup roller 120 in the deposit direction. The second pickup roller 130 may be disposed to be spaced apart from the first pickup roller 120 in the deposit direction. The second pickup roller 130 may be disposed farther from the first entry and exit port 100a than the first pickup roller 120. The second pickup roller 130 is disposed above the push plate unit 110 and can be raised and lowered by the second lifting and lowering drive unit 150. In addition, the second pickup roller 130 can be rotated by the roller rotation drive unit 650.

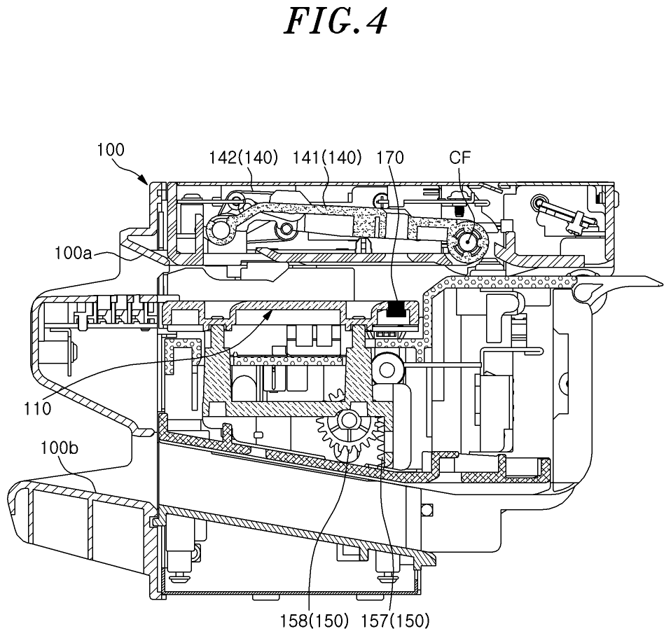

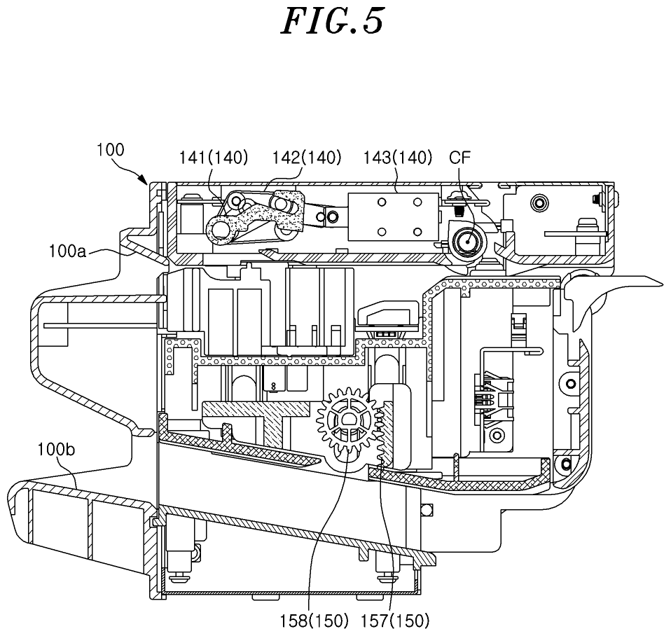

Referring to FIGS. 4 and 5, the first lifting and lowering drive unit 140 can lift and lower the first pickup roller 120. The first pickup roller 120 may not contact or may come into contact with the bundle of media 2 placed on the push plate unit 110 due to the lifting or lowering of the first pickup roller 120 by the first lifting and lowering drive unit 140. In other words, when the first pickup roller 120 is raised by the first lifting and lowering drive unit 140, the first pickup roller 120 may not come into contact with the bundle of media 2 placed on the push plate unit 110. In addition, when the first pickup roller 120 is lowered by the first lifting and lowering drive unit 140, the first pickup roller 120 may come into contact with the bundle of media 2 placed on the push plate unit 110. The first lifting and lowering drive unit 140 may be connected to the controller 700 and controlled by the controller 700. The first lifting and lowering drive unit 140 may include a first lifting and lowering support arm 141, a lifting and lowering link 142, and a link drive cylinder 143.

The first pickup roller 120 may be rotatably supported by one side of the first lifting and lowering support arm 141. In addition, the other side of the first lifting and lowering support arm 141 may be configured to be rotatable about a first arm rotation center. As the other side of the first lifting and lowering support arm 141 rotates about the first arm rotation center, the first pickup roller 120 may be raised/lowered. For example, the first arm rotation center may be the same as a rotation center CF of a feed roller 610 included in the sheet transfer unit 600, which will be described later. In other words, the other side of the first lifting and lowering support arm 141 may be rotatably disposed on a rotation shaft of the feed roller 610.

The lifting and lowering link 142 may be connected to the first lifting and lowering support arm 141. A plurality of lifting and lowering links 142 may be provided. In addition, the plurality of lifting and lowering links 142 are connected to each other, and any one of the plurality of lifting and lowering links 142 may be connected to the first lifting and lowering support arm 141. Further, another one of the plurality of lifting and lowering links 142 may be connected to the link drive cylinder 143.

The link drive cylinder 143 can drive the lifting and lowering link 142. By driving the lifting and lowering link 142 by the link drive cylinder 143, the other side of the first lifting and lowering support arm 141 can rotate about the first arm rotation center, and the first pickup roller 120 can be raised or lowered. The link drive cylinder 143 may be connected to the lifting and lowering link 142. A cylinder rod of the link drive cylinder 143 may be connected to the lifting and lowering link 142. In the case where a plurality of lifting and lowering links 142 are provided, the link drive cylinder 143 may be connected to one of the lifting and lowering links 142 except for the lifting and lowering link 142 connected to the first lifting and lowering support arm 141 among the plurality of lifting and lowering links 142. The link drive cylinder 143 may be connected to and controlled by the controller 700.

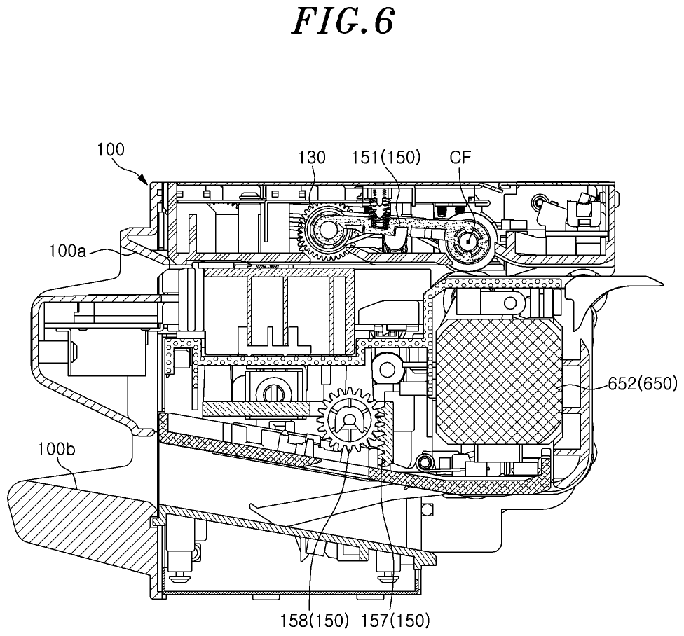

Referring to FIGS. 6 to 8, the second lifting and lowering drive unit 150 can lift and lower the second pickup roller 130. The second pickup roller 130 may not contact or may come into contact with the bundle of media 2 on the push plate unit 110 due to the lifting or lowering of the second pickup roller 130 by the second lifting and lowering drive unit 150. In other words, when the second pickup roller 130 is raised by the second lifting and lowering drive unit 150, the second pickup roller 130 may not come into contact with the bundle of media 2 placed on the push plate unit 110. In addition, when the second pickup roller 130 is lowered by the second lifting and lowering drive unit 150, the second pickup roller 130 can come into contact with the bundle of media 2 placed on the push plate unit 110. The second lifting and lowering drive unit 150 may be configured to raise/lower the push plate unit 110 while raising/lowering the second pickup roller 130. The lifting/lowering of the push plate unit 110 by the second lifting and lowering drive unit 150 can cause the push plate unit 110 to come closer to the first pickup roller 120 and the second pickup roller 130 or to move away from the first pickup roller 120 and the second pickup roller 130. The second lifting and lowering drive unit 150 may be connected to and controlled by the controller 700. The second lifting and lowering drive unit 150 may include a second lifting and lowering support arm 151, a lifting and lowering cam 152, a stopper 153, an arm lifting and lowering gear 154, a lifting and lowering drive motor 155, a torque limiter 156, a rack gear 157, a pinion gear 158, and a plate lifting and lowering gear 159.

The second pickup roller 130 may be rotatably supported by one side of the second lifting and lowering support arm 151. In addition, the other side of the second lifting and lowering support arm 151 may be configured to be rotatable about a second arm rotation center. As the other side of the second lifting and lowering support arm 151 rotates about the second arm rotation center, the second pickup roller 130 may be raised or lowered. For example, the second arm rotation center may be the same as the rotation center of the feed roller 610. In other words, the other side of the first lifting and lowering support arm 141 may be rotatably disposed on the rotation shaft of the feed roller 610.

The lifting and lowering cam 152 can lift and lower the second lifting and lowering support arm 151. The lifting and lowering cam 152 can be rotated, and the second lifting and lowering support arm 151 can be moved up or down depending on the rotational position of the lifting and lowering cam 152. The lifting and lowering cam 152 may have a stopper engagement portion 152-1 that moves along the stopper 153. In addition, the rotation range of the lifting and lowering cam 152 can be limited by the stopper 153 and the stopper engagement portion 152-1. In other words, the lifting and lowering cam 152 can be rotated within a predetermined rotation range.

The stopper 153 can limit the rotation range of the lifting and lowering cam 152. In other words, the stopper 153 can limit the lifting and lowering cam 152 to rotate within the predetermined rotation range. For example, the stopper 153 may have an arc shape and may be a groove into which the stopper engagement portion 152-1 of the lifting and lowering cam 152 can be inserted.

The arm lifting and lowering gear 154 can transmit rotational force of the lifting and lowering drive motor 155. A plurality of arm lifting and lowering gears 154 may be provided. The plurality of arm lifting and lowering gears 154 are meshed with each other, and one of the plurality of arm lifting and lowering gears 154 may be connected to the lifting and lowering cam 152 and another one may be connected to the lifting and lowering drive motor 155. One of the plurality of arm lifting and lowering gears 154 may be connected to a rotation shaft of the lifting and lowering cam 152 and another one may be connected to a rotation shaft of the lifting and lowering drive motor 155. In addition, any two of the plurality of arm lifting and lowering gears 154 that are not connected to the lifting and lowering cam 152 and the lifting and lowering drive motor 155 may be connected to the torque limiter 156.

The lifting and lowering drive motor 155 can provide rotational force. The lifting and lowering drive motor 155 can provide rotational force to rotate the lifting and lowering cam 152 so that the second lifting and lowering support arm 151 moves up or down. In addition, the lifting and lowering drive motor 155 can provide rotational force to rotate the pinion gear 158 so that the push plate unit 110 is raised or lowered. The lifting and lowering drive motor 155 may be connected to one of the plurality of arm lifting and lowering gears 154. The lifting and lowering drive motor 155 may be connected to one of the plurality of arm lifting and lowering gears 154 excluding the arm lifting and lowering gear 154 connected to the lifting and lowering cam 152 among the plurality of arm lifting and lowering gears 154. The ascending and descending drive motor 155 may be connected to and controlled by the controller 700.

The torque limiter 156 may be configured to allow the second lifting and lowering drive unit 150 to operate to raise the push plate unit 110 in a state where the lowering of the second pickup roller 130 has been completed, or to lower the second pickup roller 130 in a state where the lifting of the push plate unit 110 has been completed. In other words, the torque limiter 156 may allow the second lifting and lowering drive unit 150 to raise or lower the push plate unit 110 while raising or lowering the second pickup roller 130. In addition, even if the rotation range of the lifting and lowering cam 152 is limited by the stopper 153, the torque limiter 156 may allow the pinion gear 158 to rotate. The torque limiter 156 may be connected to any two of the plurality of arm lifting and lowering gears 154. Further, the torque limiter 156 may be connected to the plate lifting and lowering gear 159.

The rack gear 157 can work together with the pinion gear 158 to raise and lower the push plate unit 110. The rack gear 157 may be disposed on the push plate unit 110. The rack gear 157 may be disposed on the push plate unit 110 to extend in the lifting and lowering direction of the push plate unit 110.

The pinion gear 158 can work together with the rack gear 157 to raise and lower the push plate unit 110. The pinion gear 158 may be meshed with the rack gear 157 to move along the rack gear 157.

The plate lifting and lowering gear 159 can transmit the rotational force of the lifting and lowering drive motor 155 transmitted through the torque limiter 156 to the pinion gear 158. The plate lifting and lowering gear 159 may be connected to the pinion gear 158 and the torque limiter 156. The plate lifting and lowering gear 159 may be connected to a rotation shaft of the pinion gear 158.

Referring again to FIG. 3, the first medium detection sensor 160 can detect whether the bundle of media 2 has reached a region directly above the push plate unit 110. The first medium detection sensor 160 may be disposed on the push plate unit 110. The first medium detection sensor 160 may be positioned on the push plate unit 110 between the first pickup roller 120 and the second pickup roller 130. The first medium detection sensor 160 may be connected to the controller 700 and transmit information to indicate whether the bundle of media 2 has reached a region directly above the push plate unit 110 to the controller 700.

The second medium detection sensor 170 may be disposed to be spaced apart from the first medium detection sensor 160 in the deposit direction to detect the bundle of media 2. The second medium detection sensor 170 may be disposed on the push plate unit 110 to be spaced apart from the first medium detection sensor 160 in the deposit direction. In other words, the second medium detection sensor 170 may be disposed on the push plate unit 110 farther from the first entry and exit port 100a than the first medium detection sensor 160. In addition, the second medium detection sensor 170 may be disposed on the push plate unit 110 closer to the discrimination unit 200 than the first medium detection sensor 160. The second medium detection sensor 170 may be disposed on the push plate unit 110 to be spaced apart from the second pickup roller 130 in the deposit direction. The first medium detection sensor 160 may be connected to the controller 700 and transmit detection signals to the controller 700 when it detects the bundle of media 2.

The transfer assistance roller 180 can work together with the first pickup roller 120 to transfer the bundle of media 2 in the deposit direction. The transfer assistance roller 180 may be rotatably disposed below the first pickup roller 120 so as not to interfere with the lifting or lowering of the push plate unit 110.

The friction member 190 can apply frictional force to the lower medium 2-1 in the bundle of media 2 placed on the push plate unit 110. The friction member 190 may be disposed on the push plate unit 110 below the second pickup roller 130. In addition, the friction member 190 may be disposed on the push plate unit 110 between the first medium detection sensor 160 and the second medium detection sensor 170. By the frictional force applied by the friction member 190 to the lowermost medium 2-1 in the bundle of media 2 placed on the push plate unit 110, the lower medium 2-1 in the bundle of media 2 can be prevented from being dragged by the upper medium 2-1 that is moved in the deposit direction by the second pickup roller 130. In other words, even if the upper medium 2-1 of the bundle of media 2 is moved in the deposit direction by the second pickup roller 130, the lower medium 2-1 may not be moved in the deposit direction. At least a portion of the friction member 190, which comes into contact with the medium 2-1, is formed of a material with a friction coefficient greater than that of the medium 2-1, which allows it to apply friction to the lower medium 2-1 in the bundle of media 2 placed on the push plate unit 110.

Referring back to FIG. 1, the discrimination unit 200 can discriminate the medium 2-1. The discrimination unit 200 can discriminate the medium 2-1 that is transferred individually from the deposit and withdrawal unit 100 through the conveyance path 500. In addition, the discrimination unit 200 can discriminate the medium 2-1 before the medium 2-1 is stored in the storage unit 300 when the medium 2-1 is replenished in the storage unit 300 through the medium replenishment unit 400. In other words, the medium 2-1 discharged from the medium replenishment unit 400 may first be discriminated in the discrimination unit 200 and then stored in the storage unit 300. The discrimination unit 200 may discriminate the medium 2-1 for abnormalities, type, etc., and count the medium 2-1. The discrimination unit 200 may divide the medium 2-1 into normal and abnormal notes based on the discrimination results, and the normal notes may be divided into non-recyclable notes and recyclable notes.

In this case, the abnormal note refers to a medium 2-1 that cannot be processed for deposit, and may include an old medium 2-1 whose image cannot be read, a folded medium 2-1, a counterfeit note, and a suspicious note. A non-recyclable note refers to a medium 2-1 that is used only for deposits and not for withdrawals, and a recyclable note refers to a medium 2-1 that is used for both deposits and withdrawals. The non-recyclable note and the recyclable note may be distinguished based on the denomination of the medium 2-1. The recyclable note may be set as a relatively low denomination note compared to the non-recyclable note, and the non-recyclable note may be set as a relatively high denomination note compared to the recyclable note. Meanwhile, a user may also designate a non-recyclable note.

The medium 2-1 may be stored in the storage unit 300. The storage unit 300 may store the medium 2-1 based on the discrimination result by the discrimination unit 200. The storage unit 300 may include a recyclable note storage unit 310, a non-recyclable note storage unit 320, and a counterfeit note storage unit 330.

The recyclable note storage unit 310 may store a medium 2-1 discriminated as a recyclable note in the discrimination unit 200. The recyclable note storage unit 310 may be configured to include a medium storage drum 311 so that the recyclable note is wound and stored on the medium storage drum 311 using a tape (not shown) or the like. A plurality of recyclable note storage units 310 may be provided. The plurality of recyclable note storage units 310 may be stacked.

The non-recyclable note storage unit 320 may store a medium 2-1 discriminated as a non-recyclable note in the discrimination unit 200. The non-recyclable note storage unit 320 may be disposed below the counterfeit note storage unit 330.

The counterfeit note storage unit 330 may store a medium 2-1 discriminated as a counterfeit note among media 2-1 that have been discriminated as an abnormal note in the discrimination unit 200. The counterfeit note storage unit 330 may be disposed below the medium replenishment unit 400.

The medium replenishment unit 400 can replenish media 2-1 to the storage unit 300. The medium replenishment unit 400 can replenish the recyclable note storage unit 310 of the storage unit 300. The medium replenishment unit 400 may be disposed below the recyclable note storage unit 310.

The conveyance path 500 can convey the medium 2-1 between the deposit and withdrawal unit 100, the discrimination unit 200, the storage unit 300, and the sheet transfer unit 600. The conveyance path 500 may include a deposit conveyance path 510, a withdrawal conveyance path 520, a discharge conveyance path 530, a return conveyance path 540, and a gate 550.

The deposit conveyance path 510 can convey the medium 2-1 between the deposit and withdrawal unit 100, the discrimination unit 200, the storage unit 300, and the sheet transfer unit 600. The deposit conveyance path 510 may be connected to the deposit and withdrawal unit 100, the discrimination unit 200, the storage unit 300, and the sheet transfer unit 600.

The withdrawal conveyance path 520 can convey the medium 2-1 between the deposit and withdrawal unit 100 and the storage unit 300. The withdrawal conveyance path 520 may be connected to the deposit and withdrawal unit 100 and the storage unit 300. The withdrawal conveyance path 520 may be connected to the storage unit 300 through the gate 550.

The discharge conveyance path 530 can convey the medium 2-1 so that the medium 2-1 transferred through the withdrawal conveyance path 520 is discharged outside the deposit and withdrawal unit 100. The discharge conveyance path 530 may be connected to the deposit and withdrawal unit 100 and the withdrawal conveyance path 520.

When a medium 2-1 is discriminated in the discrimination unit 200 before the medium 2-1 is replenished in the storage unit 300 through the medium replenishment unit 400, the medium 2-1 discriminated in the discrimination unit 200 may stay on the return conveyance path 540 to be returned back to the discrimination unit 200. The return conveyance path 540 may be extended between the deposit conveyance path 510 and the withdrawal conveyance path 520 toward the withdrawal conveyance path 520.

The gate 550 may connect the deposit conveyance path 510 to the storage unit 300, the withdrawal conveyance path 520 to the storage unit 300, or the deposit conveyance path 510 to the withdrawal conveyance path 520. When the deposit conveyance path 510 is connected to the storage unit 300 by the gate 550, the medium 2-1 discriminated in the discrimination unit 200 can be transferred to the storage unit 300. In addition, the medium stored in the medium replenishment unit 400 can be transferred to the discrimination unit 200 after passing through the storage unit 300. When the withdrawal conveyance path 520 is connected to the storage unit 300 by the gate 550, the medium 2-1 stored in the storage unit 300 can be transferred to the withdrawal conveyance path 520. When the deposit conveyance path 510 is connected to the withdrawal conveyance path 520 by the gate 550, the medium 2-1 discriminated by the discrimination unit 200 can be transferred to the withdrawal conveyance path 520. The gate 550 may be connected to the deposit conveyance path 510, the withdrawal conveyance path 520, and the storage unit 300.

Referring again to FIG. 3, the sheet transfer unit 600 can transfer the medium 2-1 as a single sheet. The sheet transfer unit 600 can transfer the medium 2-1 deposited in the deposit and withdrawal unit 100 as a single sheet to the discrimination unit 200. The sheet transfer unit 600 is disposed between the deposit and withdrawal unit 100 and the discrimination unit 200 to be closer to the deposit and withdrawal unit 100 than to the discrimination unit 200. In addition, the sheet transfer unit 600 can transfer the medium 2-1 moved by the second pickup roller 130 of the deposit and withdrawal unit 100 as a single sheet to the discrimination unit 200. Further, when the medium 2-1 accommodated in the medium replenishment unit 400 is discharged from the medium replenishment unit 400, the sheet transfer unit 600 can transfer the medium 2-1 discharged from the medium replenishment unit 400 as a single sheet to the storage unit 300. The sheet transfer unit 600 may be disposed in the medium replenishment unit 400. The sheet transfer unit 600 may include a feed roller 610, a gate roller 620, and a roller rotation drive unit 650.

The feed roller 610 can work together with the gate roller 620 to transfer the medium 2-1 as a single sheet. The feed roller 610 may be rotated by the roller rotation drive unit 650.

The gate roller 620 can work together with the feed roller 610 to transfer the medium 2-1 as a single sheet. The gate roller 620 may be disposed below the feed roller 610. In addition, a rotation center CG of the gate roller 620 may be offset in a transfer direction of the medium 2-1 from an imaginary line VL that is perpendicular to the transfer direction of the medium 2-1 while passing through the rotation center CF of the feed roller 610.

The roller rotation drive unit 650 can rotate the feed roller 610. In addition, the roller rotation drive unit 650 can rotate the first pickup roller 120 and the second pickup roller 130. The roller rotation drive unit 650 may include a roller rotation gear 651, a roller rotation belt (not shown), and a roller rotation drive motor 652.

The roller rotation gear 651 can transmit rotational force of the roller rotation drive motor 652. A plurality of roller rotation gears 651 may be provided. Some of the plurality of roller rotation gears 651 may be meshed with each other, and one of them may be connected to the rotation shaft of the feed roller 610 and another one may be connected to a rotation shaft of the roller rotation drive motor 652, so that the rotational force of the roller rotation drive motor 652 can be transmitted to the feed roller 610. In addition, other some of the plurality of roller rotation gears 651 may connected to the rotation shaft of the feed roller 610, the rotation shaft of the first pickup roller 120, and one roller rotation belt (not shown) to transmit the rotational force of the roller rotation drive motor 652 to the first pickup roller 120 in conjunction with the corresponding roller rotation belt. In addition, still other some of the plurality of roller rotation gears 651 may be connected to the rotation shaft of the feed roller 610, the rotation shaft of the second pickup roller 130, and another roller rotation belt to transmit the rotational force of the roller rotation drive motor 652 to the second pickup roller 130 in conjunction with the corresponding roller rotation belt.

The roller rotation belt can transmit the rotational force of the roller rotation drive motor 652 to the first pickup roller 120 or the second pickup roller 130 in conjunction with the roller rotation gear 651. A plurality of roller rotation belts may be provided. For example, two roller rotation belts may be provided. In addition, one of the two roller rotation belts may be connected to the roller rotation gear 651 connected to the rotation shaft of the feed roller 610 and the roller rotation gear 651 connected to the rotation shaft of the first pickup roller 120. Further, the other of the two roller rotation belts may be connected to the roller rotation gear 651 connected to the rotation shaft of the feed roller 610 and the roller rotation gear 651 connected to the rotation shaft of the second pickup roller 130.

The roller rotation drive motor 652 can provide rotational force to rotate the feed roller 610. In addition, the roller rotation drive motor 652 can provide rotational force to rotate the first pickup roller 120 and the second pickup roller 130. The roller rotation drive motor 652 may be connected to any one of the plurality of roller rotation gears 651. The roller rotation drive motor 652 may be connected to and controlled by the controller 700.

The controller 700 can control the deposit and withdrawal unit 100, the discrimination unit 200, the storage unit 300, the medium replenishment unit 400, the conveyance path 500, and the sheet transfer unit 600. The controller 700 can control the first lifting and lowering drive unit 140 and the second lifting and lowering drive unit 150 of the deposit and withdrawal unit 100. In addition, the controller 700 can control the roller rotation drive unit 650. The controller 700 may be connected to the link drive cylinder 143 of the first lifting and lowering drive unit 140 to control the link drive cylinder 143. Further, the controller 700 may be connected to the roller rotation drive motor 652 of the roller rotation drive unit 650 to control the roller rotation drive motor 652.

The controller 700 can control the first lifting and lowering drive unit 140 and the second lifting and lowering drive unit 150 based on detection of one or both of the first medium detection sensor 160 and the second medium detection sensor 170 of the deposit and withdrawal unit 100. When the first medium detection sensor 160 detects the bundle of media 2, the controller 700 can control the first lifting and lowering drive unit 140 to lower the first pickup roller 120 to come into contact with the bundle of media 2. In other words, the controller 700 can control the link drive cylinder 143 of the first lifting and lowering drive unit 140. In addition, when the second medium detection sensor 170 detects the bundle of media 2, the controller 700 can control the second lifting and lowering drive unit 150 to lower the second pickup roller 130 to come into contact with the medium 2-1. In other words, the controller 700 can control the lifting and lowering drive motor 155 of the second lifting and lowering drive unit 150. Further, when the second medium detection sensor 170 detects the bundle of media 2, the controller 700 can control the second lifting and lowering drive unit 150 to lower the second pickup roller 130 to contact the upper surface of the bundle of media 2, and to raise the push plate unit 110 to push the bundle of media 2. In other words, the controller 700 can control the lifting and lowering drive motor 155 of the second lifting and lowering drive unit 150. In addition, when the first medium detection sensor 160 detects the bundle of media 2, the controller 700 can control the roller rotation drive unit 650 to rotate the first pickup roller 120, the second pickup roller 130, and the feed roller 610. In other words, the controller 700 can control the roller rotation drive motor 652 of the roller rotation drive unit 650. The controller 700 may be implemented by a computing device including a microprocessor, a memory, etc., and since the implementation method is obvious to those skilled in the art, a detailed description thereof will be omitted.

Hereinafter, with reference to FIGS. 9 to 14, the operation and effects of the automated teller machine 1 according to the first embodiment of the present disclosure will be described.

Referring to FIG. 9, a user can place a bundle of media 2 on the push plate unit 110 of the deposit and withdrawal unit 100 through the first entry and exit port 100a of the deposit and withdrawal unit 100. When the bundle of media 2 is placed on the push plate unit 110 by the user, the first medium detection sensor 160 can detect the bundle of media 2 and transmit a detection signal for the bundle of media 2 to the controller 700.

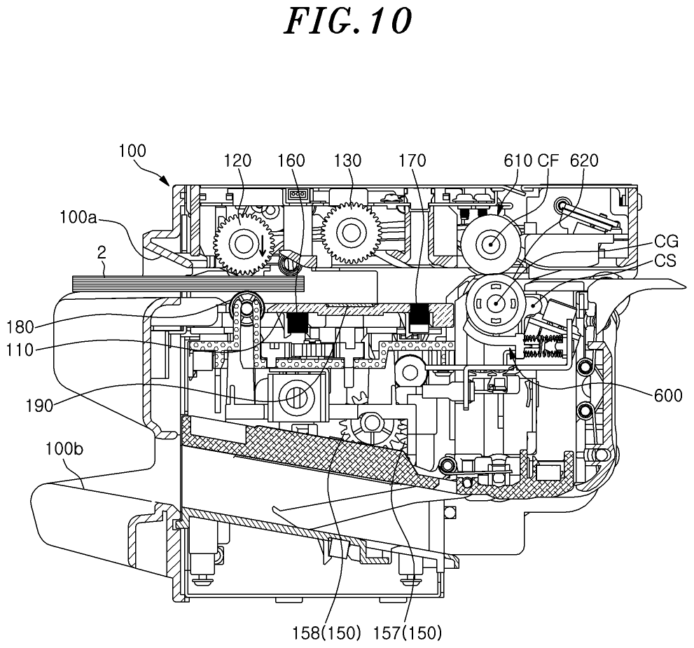

Referring to FIG. 10, when the first medium detection sensor 160 detects the bundle of media 2 placed on the push plate unit 110 and transmits the detection signal to the controller 700, the controller 700 can control the first lifting and lowering drive unit 140 to lower the first pickup roller 120 to contact the bundle of media 2. The controller 700 can control the link drive cylinder 143 of the first lifting and lowering drive unit 140 to lower the first pickup roller 120 to contact the bundle of media 2. In addition, the controller 700 can control the roller rotation drive unit 650 to rotate the first pickup roller 120. The controller 700 can control the roller rotation drive motor 652 of the roller rotation drive unit 650 to rotate the first pickup roller 120. By the controller 700 controlling the roller rotation drive motor 652 of the roller rotation drive unit 650 to rotate the first pickup roller 120, the second pickup roller 130 and the feed roller 610 can also rotate.

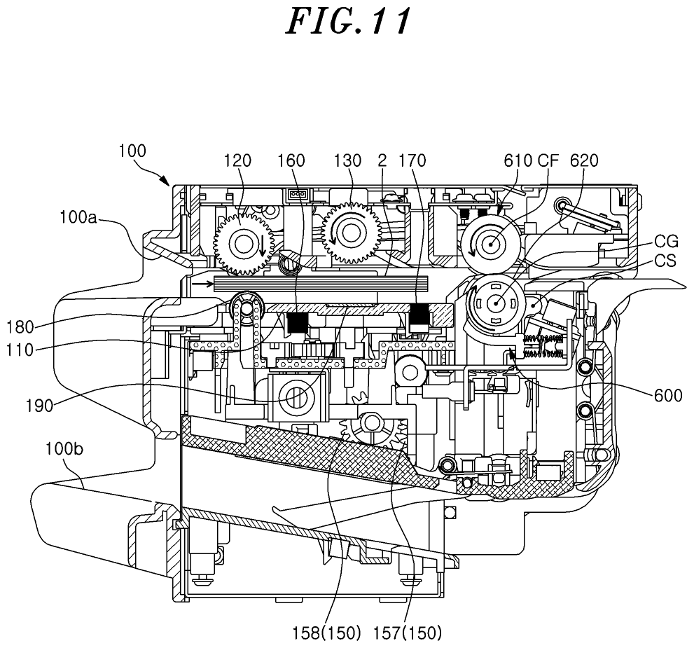

Referring to FIG. 11, due to the rotation of the first pickup roller 120, the bundle of media 2 placed on the push plate unit 110 can be transferred in the deposit direction by the first pickup roller 120 and the transfer assistance roller 180. When the bundle of media 2 is moved by a predetermined distance on the push plate unit 110 by the first pickup roller 120 and the transfer assistance roller 180, the second medium detection sensor 170 can detect the bundle of media 2 and transmit the detection signal to the controller 700.

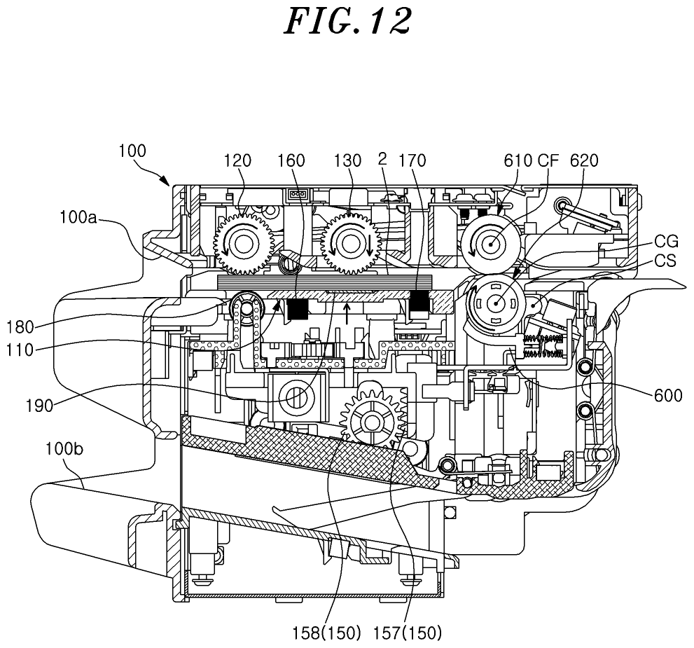

Referring to FIG. 12, when the bundle of media 2 is detected by the second medium detection sensor 170 and the detection signal is transmitted to the controller 700, the controller 700 can control the second lifting and lowering drive unit 150 to lower the second pickup roller 130 to come into contact with the bundle of media 2, and to raise the push plate unit 110. The controller 700 can control the lifting and lowering drive motor 155 of the second lifting and lowering drive unit 150 to lower the second pickup roller 130 to contact the bundle of media 2, and to raise the push plate unit 110.

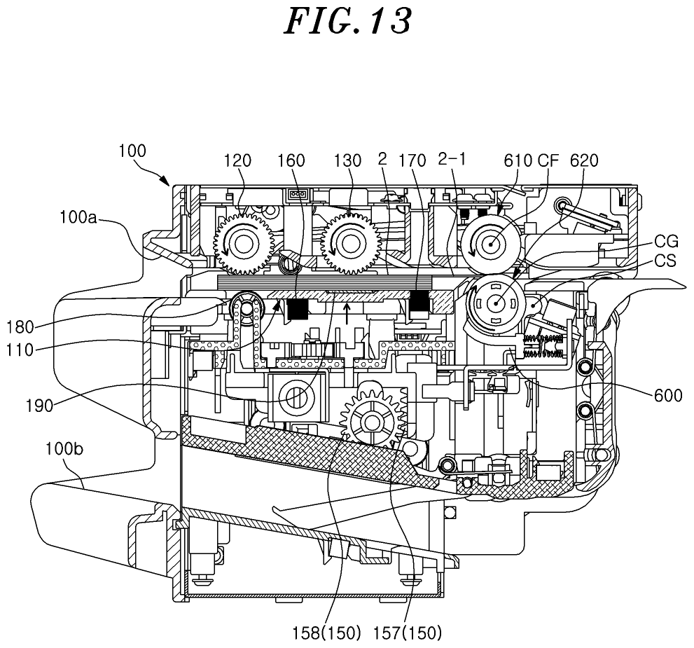

Referring to FIG. 13, when the push plate unit 110 is raised while the second pickup roller 130 is in contact with the bundle of media 2, the first pickup roller 120 can also be raised. In addition, the height of the top sheet in the bundle of media 2 becomes aligned with the gap between the feed roller 610 and the gate roller 620 of the sheet transfer unit 600.

In addition, the upper medium 2-1 of the bundle of media 2 can be transferred between the feed roller 610 and the gate roller 620 by the rotation of the first pickup roller 120 and the second pickup roller 130.

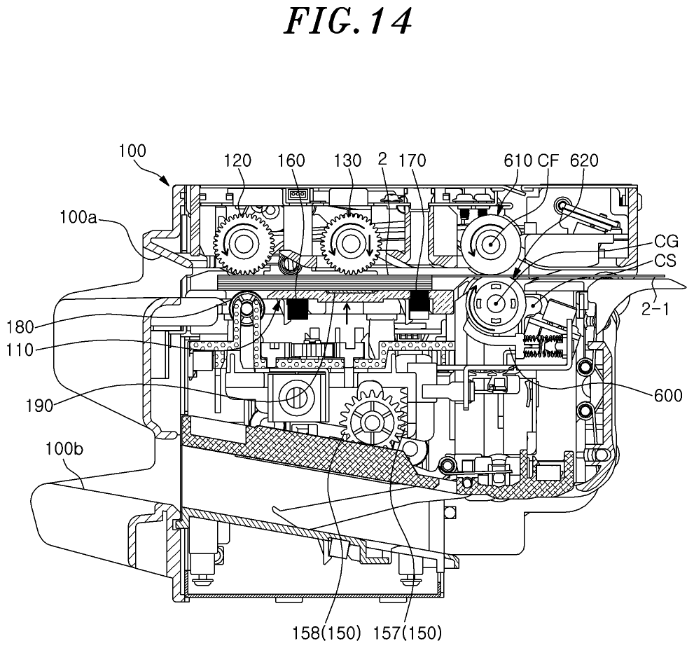

Referring to FIG. 14, the medium 2-1 transferred between the feed roller 610 and the gate roller 620 can be moved between the feed roller 610 and the gate roller 620 by the rotation of the feed roller 610 to be transferred to the discrimination unit 200 in the deposit direction.

The transfer of the medium 2-1 from the bundle of media 2 to the discrimination unit 200 can be performed until all the media 2-1 in the bundle of media 2 are transferred to the discrimination unit 200 while the push plate unit 110 is raised. Once all the media 2-1 in the bundle of media 2 have been transferred to the discrimination unit 200, the first pickup roller 120 and the second pickup roller 130 are raised and the push plate unit 110 is lowered, thereby forming a space for another bundle of media 2 to be placed on the push plate unit 110 by a user through the first entry and exit port 100a. In other words, the state of the automated teller machine 1 can be returned to the state shown in FIG. 9.

As described above, according to the embodiments of the present disclosure, there is provided a relatively simple configuration for separating bundled media 2 in which a plurality of media 2-1 such as banknotes are stacked and transferring them as individual sheets.

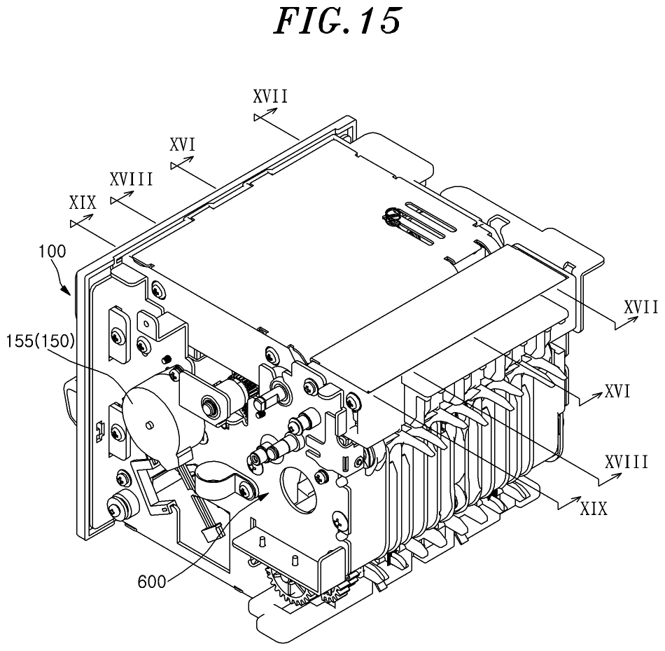

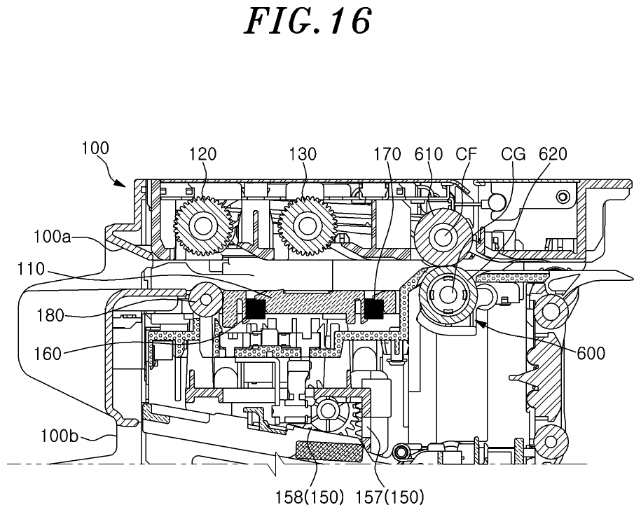

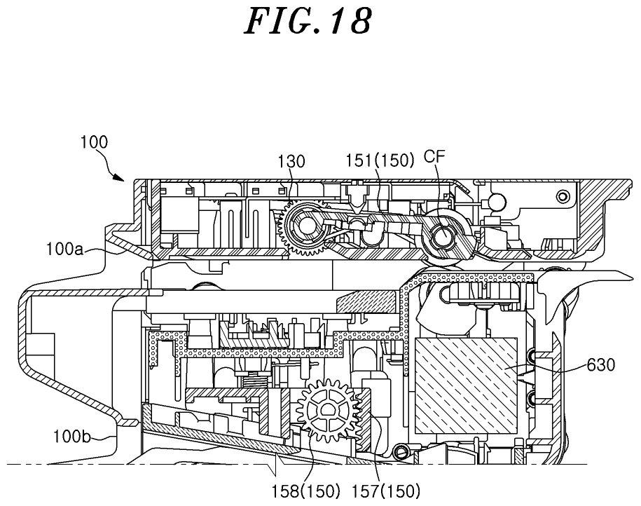

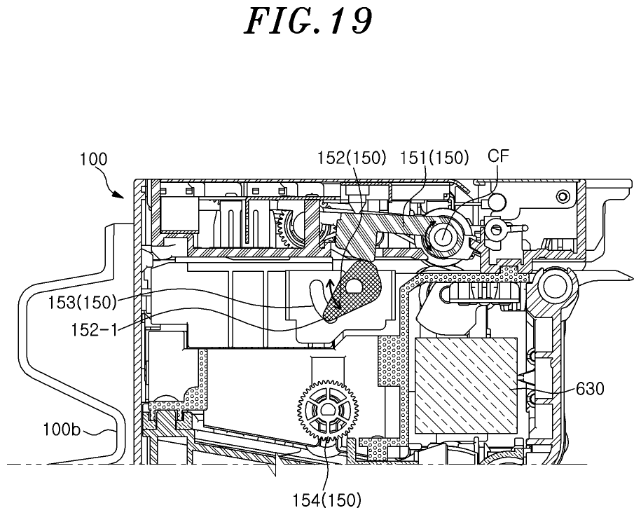

Hereinafter, an automated teller machine according to a second embodiment of the present disclosure will be described with reference to FIG. 1 and FIGS. 15 to 23. Hereinafter, in describing the automated teller machine according to the second embodiment of the present disclosure, descriptions of the same components as those of the first embodiment will be omitted, and the description will focus on the differences from the first embodiment.

The automated teller machine 1 according to the second embodiment of the present disclosure may include a deposit and withdrawal unit 100, a discrimination unit 200, a storage unit 300, a medium replenishment unit 400, a conveyance path 500, a sheet transfer unit 600, and a controller 700, and the deposit and withdrawal unit 100 may include a push plate unit 110, a first pickup roller 120, a second pickup roller 130, a first lifting and lowering drive unit 140, a second lifting and lowering drive unit 150, a first medium detection sensor 160, a second medium detection sensor 170, and a transfer assistance roller 180. Since these components are the same as those described in the first embodiment, a description thereof will be omitted.

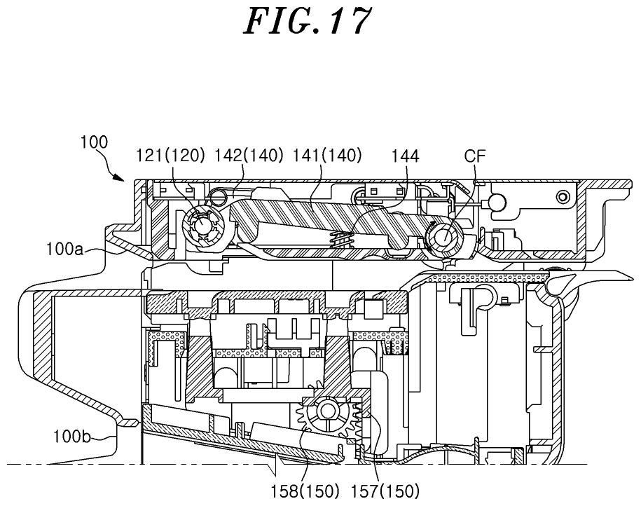

Referring to FIGS. 17 to 19, the first lifting and lowering drive unit 140 can lift and lower the first pickup roller 120. The first lifting and lowering drive unit 140 may include a first lifting and lowering support arm 141, a lifting and lowering link 142, a link drive cylinder 143, and a first elastic spring 144. In addition, a first roller shaft 121 of the first pickup roller 120 may be rotatably disposed on one side of the first lifting and lowering support arm 141.

The second lifting and lowering drive unit 150 can lift and lower the second pickup roller 130 using a lifting and lowering cam 152. The second lifting and lowering drive unit 150 can lift and lower the push plate unit 110 using a rack gear 157 and a pinion gear 158. The pushing plate unit 110 can be moved toward or away from the first pickup roller 120 and the second pickup roller 130 due to the lifting/lowering of the push plate unit 110 by the second lifting and lowering drive unit 150. The second lifting and lowering drive unit 150 may be connected to and controlled by the controller 700. The second lifting and lowering drive unit 150 may include a second lifting and lowering support arm 151, a lifting and lowering cam 152, a stopper 153, an arm lifting and lowering gear 154, a lifting and lowering drive motor 155, a rack gear 157, a pinion gear 158, and a second elastic spring (not shown).

The second elastic spring can provide elastic force to the second lifting and lowering support arm 151 in a direction to press the second pickup roller 130 against the bundle of media. For example, when the second lifting and lowering support arm 151 rotates downward by the rotation of the lifting and lowering cam 152, the second pickup roller 130 can be brought into contact with the bundle of media by the elastic force of the second elastic spring to press against it.

The arm lifting and lowering gear 154 can transmit rotational force of the lifting and lowering drive motor 155 to the pinion gear 158. The arm lifting and lowering gear 154 may be connected to the pinion gear 158 and a torque limiter 156. The arm lifting and lowering gear 154 may be connected to a rotation shaft of the pinion gear 158.

The lifting and lowering drive motor 155 can provide rotational force. The lifting and lowering drive motor 155 can provide rotational force to rotate the lifting and lowering cam 152 so that the second lifting and lowering support arm 151 moves up or down. The rotational force of the lifting and lowering drive motor 155 can be transmitted to the lifting and lowering cam 152 through an arm lifting and lowering gear. A plurality of arm lifting and lowering gears may be provided. The plurality of arm lifting and lowering gears are meshed with each other, and one of the plurality of arm lifting and lowering gears may be connected to the lifting and lowering cam 152 and another one may be connected to the lifting and lowering drive motor 155. One of the plurality of arm lifting and lowering gears may be connected to a rotation shaft of the lifting and lowering cam 152 and another one may be connected to a rotation shaft of the lifting and lowering drive motor 155.

The controller 700 can control the first lifting and lowering drive unit 140 and the second lifting and lowering drive unit 150 of the deposit and withdrawal unit 100 so that the first pickup roller 120 and the second pickup roller 130 operate together when the medium is transferred to the sheet transfer unit 600. When the first medium detection sensor 160 detects a bundle of media, the controller 700 can control the first lifting and lowering drive unit 140 to lower the first pickup roller 120 to contact the bundle of media, and when the second medium detection sensor 170 detects the bundle of media, the controller 700 can control the second lifting and lowering drive unit 150 to lower the second pickup roller 130 to contact the bundle of media.

The controller 700 can control the first lifting and lowering drive unit 140 and the second lifting and lowering drive unit 150 so that the first pickup roller 120 and the second pickup roller 130 respectively contact a front portion and a rear portion of a medium at two points when the medium is transferred to a position where the sheet transfer unit 600 is located. When the medium is transferred to the position where the sheet transfer unit 600 is located, the medium is transferred while the first pickup roller 120 and the second pickup roller 130 respectively contact the front and rear portions of the medium, so that intermittent twisting phenomenon of the medium can be prevented in advance.

Hereinafter, the operation and effects of the automated teller machine according to the second embodiment of the present disclosure will be described.

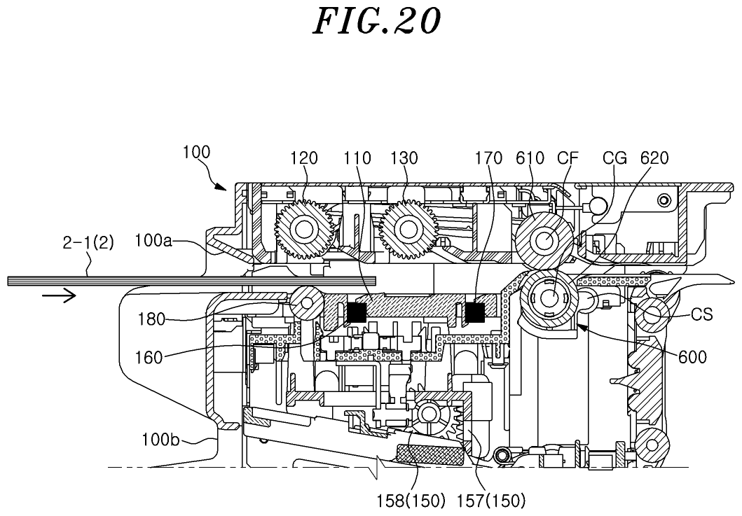

Referring to FIG. 20, when a bundle of media 2 is placed on the push plate unit 110 of the deposit and withdrawal unit 100 through the first entry and exit port 100a of the deposit and withdrawal unit 100, the first medium detection sensor 160 can detect the bundle of media 2 and transmit a detection signal for the bundle of media 2 to the controller 700.

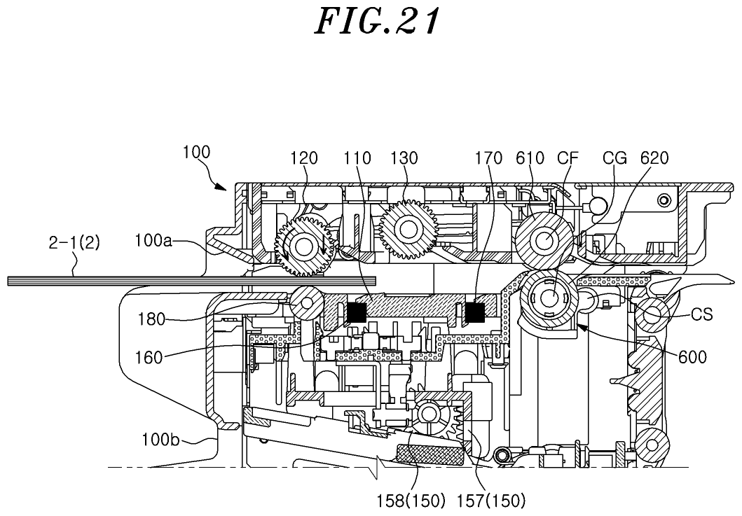

Referring to FIG. 21, when the bundle of media 2 is detected by the first medium detection sensor 160, the controller 700 can control the link drive cylinder 143 of the first lifting and lowering drive unit 140 to lower the first pickup roller 120 to come into contact with the bundle of media 2. In addition, the controller 700 can control the roller rotation drive unit 630 to rotate the first pickup roller 120. The controller 700 can control the roller rotation drive motor 652 of the roller rotation drive unit 630 to rotate the first pickup roller 120. By controlling the roller rotation drive motor 652, the second pickup roller 130 and the feed roller 610 can also rotate together with the first pickup roller 120.

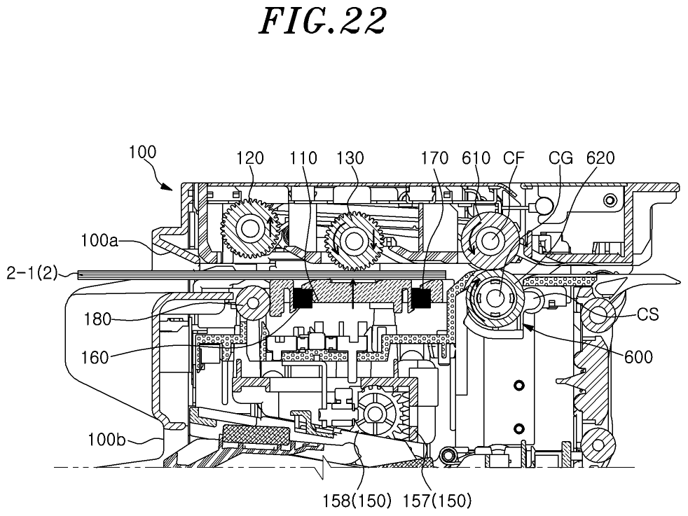

Referring to FIG. 22, due to the rotation of the first pickup roller 120, the bundle of media 2 placed on the push plate unit 110 can be transferred in the deposit direction by the first pickup roller 120 and the transfer assistance roller 180. When the bundle of media 2 is moved by a predetermined distance on the push plate unit 110 by the first pickup roller 120 and the transfer assistance roller 180, the second medium detection sensor 170 can detect the bundle of media 2 and transmit a detection signal for the bundle of media 2 to the controller 700. When the bundle of media 2 is detected by the first medium detection sensor 160, the controller 700 can control the lifting and lowering drive motor 155 of the second lifting and lowering drive unit 150 to lower the second pickup roller 130 to contact the bundle of media 2, and to raise the push plate unit 110. In this case, the height of the top sheet of the bundle of media 2 becomes aligned with the gap between the feed roller 610 and the gate roller 620 of the sheet transfer unit 600. In addition, the controller 700 can control the link drive cylinder 143 of the first lifting and lowering drive unit 140 to raise the first pickup roller 120 to be separated from the bundle of media 2.

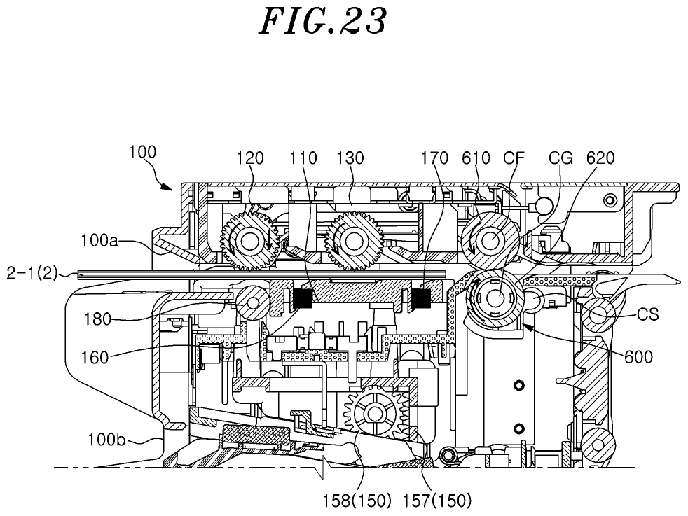

Referring to FIG. 23, the controller 700 can control the link drive cylinder 143 of the first lifting and lowering drive unit 140 to lower and lift the first pickup roller 120 to repeatedly contact and separate from the bundle of media 2. The controller 700 can control the link drive cylinder 143 of the first lifting and lowering drive unit 140 to lower and lift the first pickup roller 120 repeatedly as many times as the number of media 2-1 of the bundle of media 2. For example, when the number of media 2-1 of the bundle of media 2 is 50, the controller 700 can repeat the descending and ascending operation of the first pickup roller 120 50 times. When the first pickup roller 120 and the second pickup roller 130 contact the front and rear portions of the medium at two points, and the medium is transferred to the sheet transfer unit 600, the single sheet of medium 2-1 can be fed between the feed roller 610 and the gate roller 620 of the sheet transfer unit 600. The medium 2-1 fed between the feed roller 610 and the gate roller 620 can be transferred to the discrimination unit 200 in the deposit direction by passing between the feed roller 610 and the gate roller 620. The transfer of the medium 2-1 from the bundle of media 2 to the discrimination unit 200 can be performed until all the media 2-1 of the bundle of media 2 are transferred to the discrimination unit 200 as the push plate unit 110 is gradually raised.

As described above, according to the present disclosure, it is possible to prevent intermittent twisting of the medium in advance by having the first pickup roller and the second pickup roller contact the front and rear portions of the medium at two points when the medium is transferred to the position where the sheet transfer unit is located. In addition, according to the present disclosure, there is provided a relatively simple configuration for separating bundled media in which multiple media such as banknotes are stacked and transferring them as individual sheets.

While the present disclosure has been shown and described with respect to the preferred embodiments, the scope of the present disclosure does not limited to the particular embodiments described, and those skilled in the art may variously change and substitute components within the scope of the present disclosure, which also belong to the scope of the present disclosure.

What is claimed is:

1. An automated teller machine comprising:
a deposit and withdrawal unit configured to allow deposit and withdrawal of a medium, which allows a bundle of media including multiple stacked media to be deposited;
a discrimination unit that discriminates the medium;
a storage unit in which the medium is stored;
a conveyance path that transfers the medium between the deposit and withdrawal unit, the discrimination unit, and the storage unit,
wherein the deposit and withdrawal unit includes:
a push plate unit on which the bundle of media is placed;
a first pick-up roller for transferring the bundle of media in a deposit direction toward the discrimination unit when the bundle of media is placed on the push plate unit; and
a second pick-up roller, disposed to be spaced apart from the first pick-up roller in the deposit direction, for transferring the medium from the bundle of media in the deposit direction.

2. The automated teller machine of claim 1, further comprising a controller configured to control the deposit and withdrawal unit,
wherein the deposit and withdrawal unit further includes:
a first lifting and lowering drive unit configured to raise and lower the first pickup roller; and
a second lifting and lowering drive unit configured to raise and lower the second pickup roller, and
wherein the controller controls the first lifting and lowering drive unit and the second lifting and lowering drive unit.

3. The automated teller machine of claim 2, wherein the deposit and withdrawal unit further includes:
a first medium detection sensor for detecting whether the bundle of media has reached a region directly above the push plate unit; and
a second medium detection sensor, disposed to be spaced apart from the first medium detection sensor in the deposit direction, for detecting the bundle of media, and
wherein the controller controls the first lifting and lowering drive unit and the second lifting and lowering drive unit based on detection of one or both of the first medium detection sensor and the second medium detection sensor.

4. The automated teller machine of claim 3, wherein the first pickup roller and the second pickup roller are disposed above the push plate unit, and
the controller controls the first lifting and lowering drive unit and the second lifting and lowering drive unit to lower the first pickup roller to come into contact with the bundle of media when the first medium detection sensor detects the bundle of media, and to lower the second pickup roller to come into contact with the bundle of media when the second medium detection sensor detects the bundle of media.

5. The automated teller machine of claim 4, wherein the first lifting and lowering drive unit includes:
a first lifting and lowering support arm that rotatably supports the first pickup roller at one side and is rotatable about a first arm rotation center;
a lifting and lowering link connected to the first lifting and lowering support arm; and
a link drive cylinder connected to the lifting and lowering link.

6. The automated teller machine of claim 4, wherein the second lifting and lowering drive unit includes:
a second lifting and lowering support arm that rotatably supports the second pickup roller at one side and is rotatable about a second arm rotation center;
a lifting and lowering cam for raising and lowering the second lifting and lowering support arm;
a plurality of arm lifting and lowering gears meshed with each other, one of which is connected to the lifting and lowering cam; and
a lifting and lowering drive motor connected to another one of the plurality of arm lifting and lowering gears.

7. The automated teller machine of claim 6, wherein the second lifting and lowering drive unit further includes a stopper that limits a rotation range of the lifting and lowering cam, and
the lifting and lowering cam has a stopper engagement portion that moves along the stopper.

8. The automated teller machine of claim 6, wherein the second lifting and lowering drive unit further includes at least one torque limiter configured to allow the second lifting and lowering drive unit to operate to raise the push plate unit in a state where lowering of the second pickup roller has been completed, or to allow the second lifting and lowering drive unit to operate to lower the second pickup roller in a state where lifting of the push plate unit has been completed.

9. The automated teller machine of claim 8, wherein the second lifting and lowering drive unit is configured to raise and lower the push plate unit while raising and lowering the second pickup roller.

10. The automated teller machine of claim 9, wherein when the second medium detection sensor detects the bundle of media, the controller controls the second lifting and lowering drive unit to lower the second pickup roller to contact an upper surface of the bundle of media, and to raise the push plate unit to push the bundle of media upward.

11. The automated teller machine of claim 10, wherein the second lifting and lowering drive unit further includes:
a rack gear disposed on the push plate unit;
a pinion gear meshed with the rack gear to move along the rack gear; and
a plate lifting and lowering gear connected to the pinion gear and the torque limiter.

12. The automated teller machine of claim 1, wherein the deposit and withdrawal unit further includes a transfer assistance roller for working together with the first pickup roller to transfer the bundle of media in the deposit direction.

13. The automated teller machine of claim 4, wherein the deposit and withdrawal unit further includes a friction member disposed on the push plate unit below the second pickup roller.

14. An automated teller machine comprising:
a deposit and withdrawal unit configured to allow deposit and withdrawal of media as a bundle of media in which multiple media are stacked;
a discrimination unit that discriminates the media;
a sheet transfer unit that transfers media separated into individual sheets from the bundle of media to the discrimination unit; and
a controller configured to control the deposit and withdrawal unit, the discrimination unit, and the sheet transfer unit,
wherein the deposit and withdrawal unit includes:
a push plate unit on which the bundle of media is placed;
a first pick-up roller for transferring the bundle of media in a deposit direction of the media when the bundle of media is placed on the push plate unit; and
a second pick-up roller, disposed to be spaced apart from the first pick-up roller in the deposit direction, for providing the media of the bundle of media to the sheet transfer unit, and
wherein the controller controls the first pick-up roller and the second pick-up roller to operate together when the media are conveyed to the sheet transfer unit.

15. The automated teller machine of claim 14, wherein the deposit and withdrawal unit further includes:
a first medium detection sensor disposed between the first pickup roller and the second pickup roller to detect whether at least a portion of the bundle of media has reached a region directly above the push plate unit;
a second medium detection sensor disposed between the second pickup roller and the sheet transfer unit to detect whether at least a portion of the bundle of media has reached a standby position before being fed into the sheet transfer unit;
a first lifting and lowering drive unit configured to raise and lower the first pickup roller; and
a second lifting and lowering drive unit configured to raise and lower the second pickup roller, and
wherein the controller controls the first lifting and lowering drive unit and the second lifting and lowering drive unit to lower the first pickup roller to come into contact with the bundle of media when the first medium detection sensor detects the bundle of media, and to lower the second pickup roller to come into contact with the bundle of media when the second medium detection sensor detects the bundle of media.

16. The automated teller machine of claim 15, wherein the first lifting and lowering drive unit includes:
a first lifting and lowering support arm that rotatably supports the first pickup roller at one side and is rotatable about a first arm rotation center;
a lifting and lowering link connected to the first lifting and lowering support arm;
a link drive cylinder connected to the lifting and lowering link; and
a first elastic spring that provides elastic force to the first lifting and lowering support arm to move the first pickup roller to its initial position when the link drive cylinder is not operated.

17. The automated teller machine of claim 16, wherein the controller controls the first lifting and lowering drive unit to lower the first pickup roller to come into contact with the bundle of media when the first medium detection sensor detects the bundle of media, to raise the first pickup roller to be separated from the bundle of media when the second medium detection sensor detects the bundle of media, and to lower and raise the first pickup roller for a preset period of time to repeatedly contact and separate from the bundle of media.

18. The automated teller machine of claim 15, wherein the second lifting and lowering drive unit includes:
a second lifting and lowering support arm that rotatably supports the second pickup roller at one side and is rotatable about a second arm rotation center;
a lifting and lowering cam for lifting and lowering the second lifting and lowering support arm;
a plurality of arm lifting and lowering gears meshed with each other, one of which is connected to the lifting and lowering cam;
a lifting and lowering drive motor connected to another one of the plurality of arm lifting and lowering gears; and
a second elastic spring that provides elastic force to the second lifting and lowering support arm in a direction to press the second pickup roller against the bundle of media.

19. The automated teller machine of claim 15, wherein the second lifting and lowering drive unit raises and lowers the second pickup roller and the push plate unit together so that the second pickup roller and the push plate unit move away from or closer to each other.

20. The automated teller machine of claim 19, wherein when the second medium detection sensor detects the bundle of media, the controller controls the second lifting and lowering drive unit to lower the second pickup roller to contact an upper surface of the bundle of media, and to raise the push plate unit to push the bundle of media upward.
